(19) United States
(12) Patent Application Publication
(10) Pub. No.: US 2024/0208822 A1
(43) Pub. Date: Jun. 27, 2024

(54) GRAPHENE MANUFACTURING METHOD

(71) Applicant: HAMAMATSU PHOTONICS K.K., Hamamatsu-shi (JP)

(72) Inventors: Atsushi NAKANISHI, Hamamatsu-shi (JP); Yuta KINE, Hamamatsu-shi (JP); Takeshi WATARI, Hamamatsu-shi (JP); Takashi KURITA, Hamamatsu-shi (JP)

(73) Assignee: HAMAMATSU PHOTONICS K.K., Hamamatsu-shi (JP)

(21) Appl. No.: 18/545,069

(22) Filed: Dec. 19, 2023

(30) Foreign Application Priority Data
Dec. 27, 2022 (JP) 2022-209586

(51) Int. Cl. C01B 32/184; B23K 26/0622; B23K 26/70

(52) U.S. Cl. CPC C01B 32/184; B23K 26/0624; B23K 26/705

(57) ABSTRACT

A graphene manufacturing method includes a step of preparing a workpiece including a base material made of a resin material and a plant powder dispersed in the base material, a step of irradiating a surface of the workpiece with a terahertz wave and an evaluation laser beam and detecting the terahertz wave from the surface, a step of irradiating a processing region of the surface with a processing laser beam to form graphene in the processing region, a step of irradiating the processing region with the terahertz wave and the evaluation laser beam and detecting the terahertz wave from the processing region, and a step of evaluating quality of the graphene in the processing region based on an intensity difference between the terahertz wave detected in the step and the terahertz wave detected in the step.

### TECHNICAL FIELD

The present disclosure relates to a graphene manufacturing method.

### BACKGROUND

Conventionally, as a technique related to manufacturing of graphene, for example, “Green Flexible Graphene-Inorganic-Hybrid Micro-Supercapacitors Made of Fallen Leaves Enabled by Ultrafast Laser Pulses” (Adv.Funct.Mater. 2021, 2107768, Truong-Son Dinh Le, and other 9 persons) discloses a technique for forming graphene by irradiating a surface of a workpiece (for example, a plant) with a processing laser beam.

### SUMMARY

In the technique as described above, the quality of graphene may depend on, for example, a radiation condition of the processing laser beam. When graphene is formed on the surface of a predetermined workpiece, if the radiation condition of the processing laser beam is not appropriately set, manufacturing of high quality graphene may be difficult.

An objective of the present disclosure is to provide a graphene manufacturing method capable of realizing the manufacturing of high quality graphene.

A graphene manufacturing method of the present disclosure is “A graphene manufacturing method including a first step of preparing a workpiece including a base material made of a resin material and a plant powder dispersed in the base material, a second step of irradiating a surface of the workpiece with a terahertz wave and an evaluation laser beam and detecting the terahertz wave from the surface, a third step of irradiating a processing region of the surface with a processing laser beam to form graphene in the processing region, a fourth step of irradiating the processing region with the terahertz wave and the evaluation laser beam and detecting the terahertz wave from the processing region, and a fifth step of evaluating quality of the graphene in the processing region based on an intensity difference between the terahertz wave detected in the fourth step and the terahertz wave detected in the second step.”.

### BRIEF DESCRIPTION OF THE DRAWINGS

FIG. 1 is a configuration diagram of a graphene manufacturing apparatus according to a first embodiment;

FIG. 2 is a plan view of a surface of a workpiece illustrated in FIG. 1;

FIG. 3 is a flowchart of a graphene manufacturing method using the graphene manufacturing apparatus illustrated in FIG. 1;

FIG. 4 is a configuration diagram of a graphene manufacturing apparatus according to a second embodiment;

FIG. 5 is a configuration diagram of a graphene manufacturing apparatus according to a third embodiment;

FIG. 6 is a configuration diagram of a graphene manufacturing apparatus according to a fourth embodiment;

FIG. 7 is a configuration diagram of a graphene manufacturing apparatus according to a fifth embodiment;

FIG. 8 is a configuration diagram of a graphene manufacturing apparatus according to a sixth embodiment;

FIG. 9 is a configuration diagram of a graphene manufacturing apparatus according to a seventh embodiment;

FIG. 10 is a configuration diagram of a graphene manufacturing apparatus according to an eighth embodiment;

FIG. 11 is a configuration diagram of a graphene manufacturing apparatus according to a ninth embodiment; and

FIG. 12 is a diagram illustrating a graphene manufacturing method according to a modified example.

### DETAILED DESCRIPTION

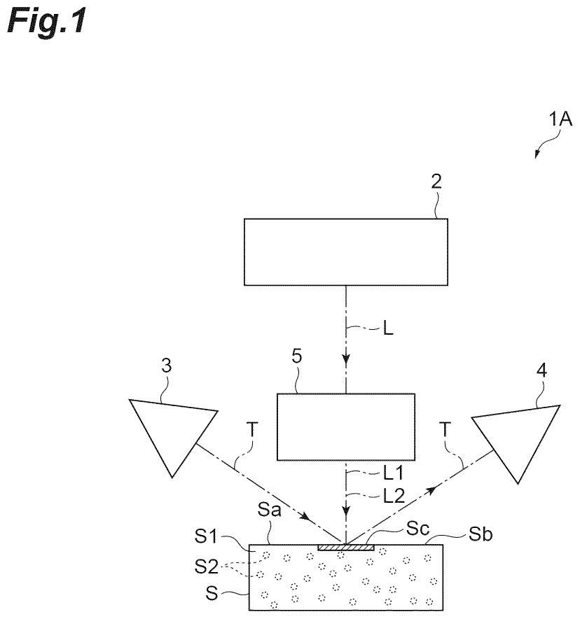

Hereinafter, embodiments of the present disclosure will be described in detail with reference to the drawings. In the drawings, the same or corresponding parts are denoted by the same reference numerals, and redundant description will be omitted.

[First Embodiment] FIG. 1 is a configuration diagram of a graphene manufacturing apparatus according to a first embodiment. As illustrated in FIG. 1, a graphene manufacturing apparatus 1A according to the first embodiment is an apparatus for forming a graphene Sc in a processing region Sb on a surface Sa of a workpiece S. The graphene Sc functions as, for example, a transparent electrode, a wiring, or a capacitor electrode material. The workpiece S having the graphene Sc functioning in this manner is used as, for example, an electronic device.

The workpiece S contains a base material S1 and a plant powder S2. The base material S1 is made of a resin material. The base material S1 is, for example, a thermoplastic resin. The base material S1 contains, for example, at least one of polypropylene (PP), nylon 6 (PA6), acrylonitrile, butadiene, and a styrene copolymer synthetic resin (ABS resin). The plant powder S2 is dispersed in the base material S1. The plant powder S2 is uniformly dispersed in, for example, the base material S1. The plant powder S2 contains, for example, at least one of a wood powder and a bamboo powder. The plant powder S2 contains, for example, cellulose or lignin. The content of the plant powder S2 in the workpiece S is, for example, 30 wt % or more. The content of the plant powder S2 in the workpiece S may be, for example, less than 30 wt %. The workpiece S may contain an admixture or the like. The workpiece S is manufactured by extrusion molding, injection molding, or the like. The workpiece S has, for example, a plate shape.

The workpiece S is, for example, a so-called wood plastic (WPC: woodfiber-plastic composite). The wood plastic is a composite of the wood powder and a thermoplastic plastic. The wood powder is manufactured from, for example, unused biomass (for example, thinned wood). Therefore, the use of the wood plastic is environmentally friendly. In addition, the wood plastic is superior in durability to wood. The appearance of the wood plastic is similar to the appearance of the wood. Therefore, the wood plastic is easily accepted without resistance even when used for a wood application.

A graphene manufacturing apparatus 1A includes a laser beam source 2, a terahertz light source 3, a photodetector 4, and an optical element 5. The laser beam source 2 emits a laser beam L. In the present embodiment, the laser beam source 2 emits the laser beam L along a direction perpendicular to the surface Sa. The laser beam source 2 irradiates the processing region Sb of the surface Sa of the workpiece S with the laser beam L. The laser beam L is, for example, a femtosecond laser beam. The wavelength of the laser beam L is, for example, about several hundred nm.

The terahertz light source 3 emits a terahertz wave T. In the present embodiment, the terahertz light source 3 emits the terahertz wave T along a direction inclined with respect to the surface Sa. The terahertz light source 3 irradiates the processing region Sb with the terahertz wave T. The terahertz wave T is reflected by the processing region Sb. The terahertz wave T has an intermediate property between an optical wave and a radio wave. The terahertz wave T is an electromagnetic wave having a frequency corresponding to an intermediate region between the optical wave and the radio wave. The frequency of the terahertz wave T is from about 0.01 THz to about 100 THz.

The photodetector 4 detects the terahertz wave T from the workpiece S. In the present embodiment, the photodetector 4 detects the terahertz wave T reflected by the processing region Sb. The photodetector 4 transmits a detection result of the terahertz wave T to a control device.

The optical element 5 is disposed between the laser beam source 2 and the workpiece S. The optical element 5 is disposed in an optical path of the laser beam L emitted from the laser beam source 2. The optical element 5 converts a part of the laser beam L emitted from the laser beam source 2 into a processing laser beam L1. The processing laser beam L1 emitted from the optical element 5 is incident on the processing region Sb along a direction perpendicular to the surface Sa.

The optical element 5 transmits the other part of the laser beam L emitted from the laser beam source 2. The laser beam L transmitted through the optical element 5 is incident on, as an evaluation laser beam L2, the processing region Sb along the direction perpendicular to the surface Sa. The optical element 5 is, for example, a wavelength conversion element. The optical element 5 is made of, for example, a nonlinear optical crystal. The nonlinear optical crystal is, for example, lithium niobate (LiNbO₃).

As described above, the processing laser beam L1 and the evaluation laser beam L2 are emitted from the same laser beam source (laser beam source 2). Each of the processing laser beam L1 and the evaluation laser beam L2 is, for example, the femtosecond laser beam. The wavelength of the processing laser beam L1 and the wavelength of the evaluation laser beam L2 are different from each other. The processing laser beam L1 is, for example, ultraviolet light. The wavelength of the processing laser beam L1 is, for example, about several hundred nm. The wavelength of the evaluation laser beam L2 is larger than the wavelength of the processing laser beam L1. The wavelength of the evaluation laser beam L2 is the same as the wavelength of the laser beam L.

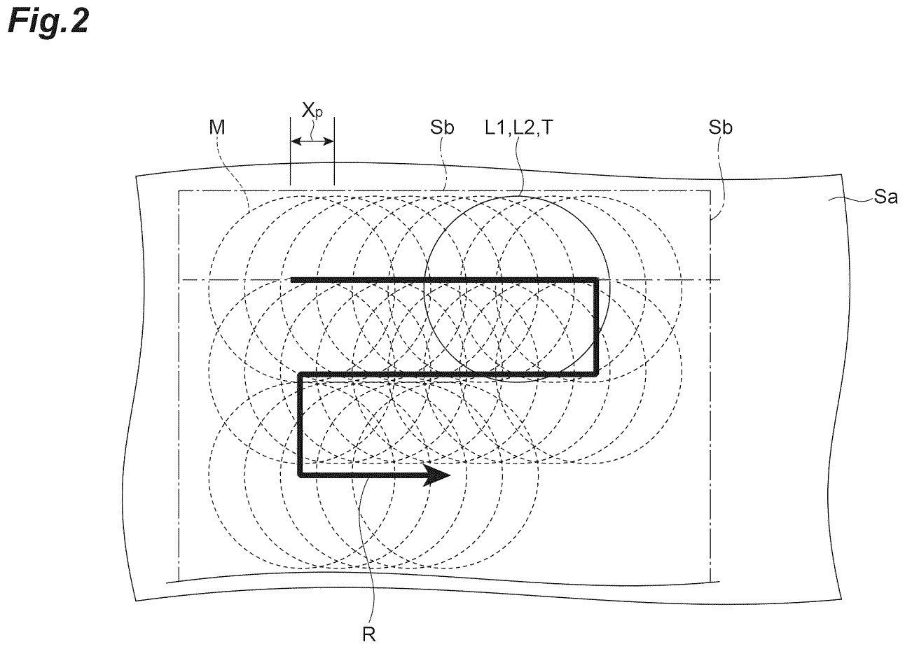

As illustrated in FIG. 2, the processing laser beam L1 scans over the entire processing region Sb. Specifically, the processing laser beam L1 is radiated to the processing region Sb such that the center of an irradiation range M moves along a path R. The path R has, for example, a meandering shape. The processing laser beam L1 is intermittently radiated at every processing pitch Xp. That is, the processing laser beam L1 is radiated to a first position and then radiated again to a second position away from the first position by the processing pitch Xp. The processing pitch Xp is a distance between the centers of adjacent ones of the irradiation ranges M. As a result, the graphene Sc (see FIG. 1) is formed in the processing region Sb. That is, the processing region Sb is modified into the graphene Sc.

In the present embodiment, an irradiation position of the terahertz wave T in the processing region Sb overlaps an irradiation position of the processing laser beam L1 in the processing region Sb. The terahertz wave T is radiated to the same position at the same time as the processing laser beam L1. Similarly to the processing laser beam L1, the terahertz wave T scans over the entire processing region Sb. Similarly to the processing laser beam L1, the terahertz wave T is intermittently radiated at every processing pitch Xp.

The irradiation position of the evaluation laser beam L2 in the processing region Sb overlaps the irradiation position of the terahertz wave T in the processing region Sb. In the present embodiment, the irradiation position of the evaluation laser beam L2 in the processing region Sb overlaps the irradiation position of the processing laser beam L1 in the processing region Sb. The evaluation laser beam L2 is radiated to the same position at the same time as the terahertz wave T. In the present embodiment, the evaluation laser beam L2 is radiated to the same position at the same time as the processing laser beam L1.

Similarly to the terahertz wave T, the evaluation laser beam L2 scans over the entire processing region Sb. Similarly to the terahertz wave T, the evaluation laser beam L2 is intermittently radiated at every processing pitch Xp. The evaluation laser beam L2 enhances the terahertz wave T incident on the processing region Sb or the terahertz wave T reflected by the processing region Sb. Specifically, when the graphene Sc is irradiated with the evaluation laser beam L2, an electric field is formed. The terahertz wave T is enhanced by the electric field.

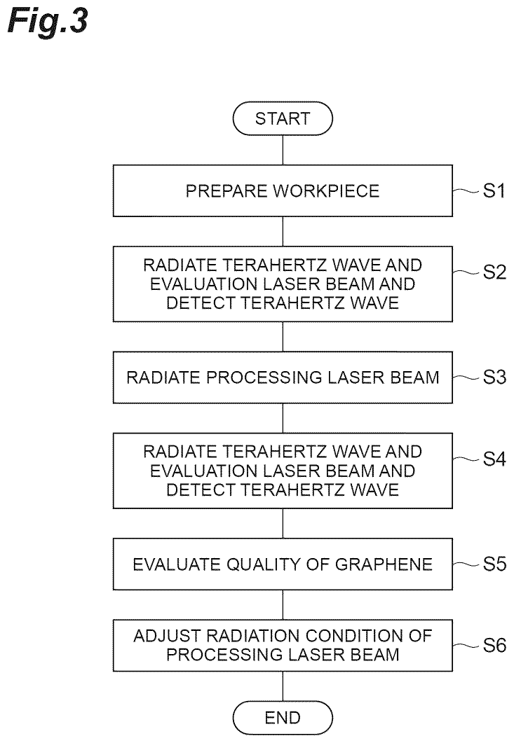

Next, the graphene manufacturing method according to the first embodiment will be described. The graphene manufacturing method is a method of forming the graphene Sc on the surface Sa of the workpiece S. As illustrated in FIG. 3, in step S1, the workpiece S is prepared. Step S1 corresponds to a first step.

In step S2, the surface Sa is irradiated with the terahertz wave T and the evaluation laser beam L2, and the terahertz wave T from the surface Sa is detected. As a result, a reference value before the graphene Sc is formed is obtained. In step S2, only one position in the processing region Sb may be irradiated with the terahertz wave T and the evaluation laser beam L2. Step S2 corresponds to a second step.

In step S3, the processing region Sb is irradiated with the processing laser beam L1. In step S3, as described above, the processing laser beam L1 scans over the entire processing region Sb. As a result, the graphene Sc is formed in the processing region Sb. Step S3 corresponds to a third step.

In step S4, the processing region Sb is irradiated with the terahertz wave T and the evaluation laser beam L2, and the terahertz wave T from the processing region Sb is detected. In the present embodiment, the wavelength of the terahertz wave T radiated in step S4 is the same as the wavelength of the terahertz wave T radiated in step S2. In the present embodiment, the wavelength of the evaluation laser beam L2 radiated in step S4 is the same as the wavelength of the evaluation laser beam L2 radiated in step S2. In step S4, as described above, the terahertz wave T and the evaluation laser beam L2 scan over the entire processing region Sb. In step S4, as described above, the terahertz wave T and the evaluation laser beam L2 are radiated to the same position at the same time. Step S4 corresponds to a fourth step.

In step S5, a quality of the graphene Sc in the processing region Sb is evaluated based on an intensity difference between the terahertz wave T detected in step S4 and the terahertz wave T detected in step S2 (hereinafter, referred to as “intensity difference”). The quality of graphene refers to a degree of formation of graphene. For example, the quality of graphene is higher when graphene is formed, than when graphene is not formed. For example, the more uniformly a lattice structure of graphene is distributed, the higher the quality of graphene is. For example, the less defects in the lattice structure of graphene is, the higher the quality of graphene is. The higher the quality of graphene is, the more electron mobility is improved, and as a result, the higher a value as an electronic material is.

In step S5, for example, when the intensity difference is a predetermined value or more, the quality of the graphene Sc is evaluated to be high. In step S5, for example, when the intensity difference is smaller than a predetermined value, the quality of the graphene Sc is evaluated to be low. The predetermined value is a threshold value determined in advance for evaluating the quality of the graphene Sc. The predetermined value is determined, for example, for each type of the workpiece S. In step S5, the larger the intensity difference is, the higher the quality of the graphene Sc is evaluated. In step S5, a difference between the quality of the graphene Sc and a reference quality (desired quality) may be evaluated. Step S5 corresponds to a fifth step. Steps S3 and S4 are simultaneously executed. That is, the quality of the graphene Sc is evaluated in real time while the graphene Sc is manufactured.

In step S6, the radiation condition of the processing laser beam L1 with respect to the processing region Sb is adjusted based on the evaluation result in step S5. The radiation condition of the processing laser beam L1 includes, for example, an average output, a pulse energy, an intensity, fluence, a radiation time, a pulse width, a wavelength, a beam diameter, and a processing pitch, of the processing laser beam L1. In step S6, at least one of these radiation conditions of the processing laser beam L1 is changed.

In step S6, for example, when the intensity difference is smaller than the predetermined value, that is, when the quality of the graphene Sc is evaluated to be low in step S5, an energy of the processing laser beam L1 incident on the processing region Sb is increased. In step S6, for example, at least one of the average output, the pulse energy, the intensity, the fluence, the radiation time, and the processing pitch of the processing laser beam L1 is increased. In step S6, for example, at least one of the pulse width, the wavelength, and the processing pitch of the processing laser beam L1 is decreased. Step S6 corresponds to a sixth step.

As described above, in step S5 (fifth step) of the graphene manufacturing method, the quality of the graphene Sc in the processing region Sb is evaluated based on the intensity difference between the terahertz wave detected in step S4 and the terahertz wave detected in step S2. That is, in step S5, the quality of the graphene Sc is evaluated using, for example, the terahertz wave T having a longer wavelength than visible light or infrared light. As a result, for example, even when unevenness or the like exists in the processing region Sb, noise caused by the unevenness is reduced, and thus the quality of the graphene Sc can be evaluated with higher accuracy. Moreover, in step S4 (fourth step), the processing region Sb is irradiated with the evaluation laser beam L2 in addition to the terahertz wave T. As a result, when the graphene Sc is formed in the processing region Sb, the terahertz wave T is enhanced, and thus the quality of the graphene Sc can be evaluated with further higher accuracy. Therefore, highly accurate setting of the radiation condition of the processing laser beam L1 can be realized based on the highly accurate evaluation result of the quality of the graphene Sc. Therefore, according to this graphene manufacturing method, manufacturing of the high quality graphene Sc can be realized.

In step S5 (fifth step) of the above-described graphene manufacturing method, the larger the intensity difference of the terahertz wave T is, the higher the quality of the graphene Sc is evaluated. As a result, highly accurate setting of the radiation condition of the processing laser beam L1 can be realized, and the manufacturing of the high quality graphene Sc can be realized.

In step S6 (sixth step) of the graphene manufacturing method, the radiation condition of the processing laser beam L1 with respect to the processing region Sb is adjusted based on the evaluation result in step S5. As a result, the radiation condition of the processing laser beam L1 can be set with high accuracy, and the high quality graphene Sc can be manufactured.

In step S6 of the graphene manufacturing method, when the intensity difference of the terahertz wave T is smaller than the predetermined value, the energy of the processing laser beam L1 incident on the processing region Sb is increased. When the intensity difference is smaller than the predetermined value, the quality of the graphene Sc may not meet a predetermined condition. According to this method, when the intensity difference is smaller than the predetermined value, the quality of the graphene Sc can be improved by increasing the energy of the processing laser beam L1.

Steps S3 and S4 of the graphene manufacturing method are simultaneously executed. As a result, the quality of the graphene Sc is evaluated in real time while the graphene Sc is manufactured. Therefore, improvement of manufacturing efficiency of the high quality graphene Sc can be realized. In addition, an optimal radiation condition of the processing laser beam L1 can be efficiently searched.

The processing laser beam L1 and the evaluation laser beam L2 are emitted from the same laser beam source (laser beam source 2). As a result, for example, as compared with a case where each of the processing laser beam L1 and the evaluation laser beam L2 is emitted from a respective one of different laser beam sources, the manufacturing of the graphene Sc with a simple configuration can be realized.

Each of the processing laser beam L1 and the evaluation laser beam L2 is the femtosecond laser beam. As a result, the manufacturing of the graphene Sc with the simple configuration can be realized.

The irradiation position of the processing laser beam L1 and the irradiation position of the evaluation laser beam L2 in the processing region Sb overlap each other. As a result, the manufacturing of the graphene Sc and the quality evaluation of the graphene Sc can be simultaneously executed, and the improvement of the manufacturing efficiency of the graphene Sc can be realized.

The wavelength of the processing laser beam L1 incident on the processing region Sb and the wavelength of the evaluation laser beam L2 incident on the processing region Sb are different from each other. As a result, laser beams each having a wavelength suitable for a respective one of the manufacturing of the graphene Sc and the quality evaluation of the graphene Sc can be used, and the accuracy of each of the manufacturing of the graphene Sc and the quality evaluation of the graphene Sc can be improved.

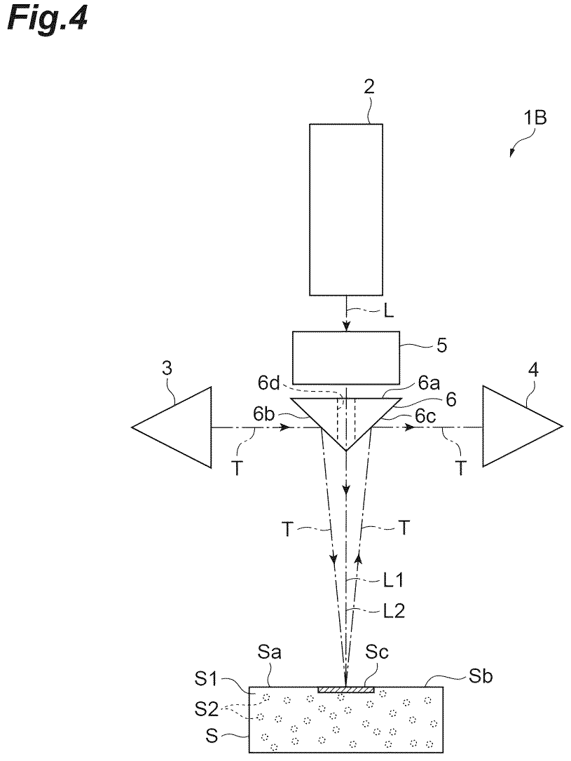

The wavelength of the evaluation laser beam L2 is larger than the wavelength of the processing laser beam L1. As a result, laser beams each having a wavelength suitable for a respective one of the manufacturing of the graphene Sc and the quality evaluation of the graphene Sc can be used, and the accuracy of each of the manufacturing of the graphene Sc and the quality evaluation of the graphene Sc can be improved.

[Second Embodiment] FIG. 4 is a configuration diagram of a graphene manufacturing apparatus according to a second embodiment. As illustrated in FIG. 4, a graphene manufacturing apparatus 1B according to the second embodiment is mainly different from the graphene manufacturing apparatus 1A according to the first embodiment in that a prism 6 is further provided.

The prism 6 is disposed between the optical element 5 and the workpiece S. The cross section of the prism 6 has, for example, a triangular shape. The prism 6 includes an incident surface 6a, a reflecting surface 6b, a reflecting surface 6c, and a through hole 6d. The incident surface 6a faces the laser beam source 2 via the optical element 5. The incident surface 6a is parallel to the surface Sa of the workpiece S.

The reflecting surface 6b faces between the terahertz light source 3 and the workpiece S. The reflecting surface 6b is inclined with respect to the surface Sa of the workpiece S. In the present embodiment, the terahertz light source 3 emits the terahertz wave T along a direction parallel to the surface Sa.

The reflecting surface 6c faces between the photodetector 4 and the workpiece S. The reflecting surface 6c is inclined with respect to the surface Sa of the workpiece S. A width between the reflecting surface 6c and the reflecting surface 6b gradually decreases from the laser beam source 2 toward the workpiece S. The through hole 6d penetrates the prism 6 in a direction perpendicular to the incident surface 6a.

The processing laser beam L1 emitted from the optical element 5 and the evaluation laser beam L2 transmitted through the optical element 5 pass through the through hole 6d and then are incident on the processing region Sb of the surface Sa of the workpiece S. The terahertz wave T emitted from the terahertz light source 3 is reflected by the reflecting surface 6b and then incident on the processing region Sb. The terahertz wave T reflected by the processing region Sb is reflected by the reflecting surface 6c and then incident on the photodetector 4.

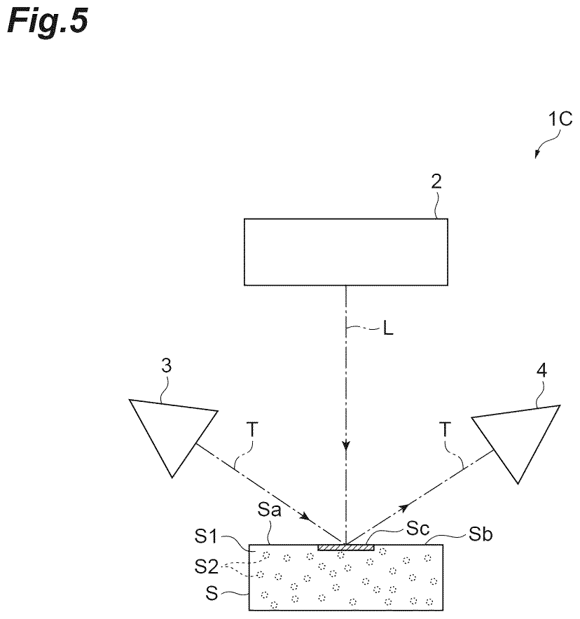

According to the graphene manufacturing method using the graphene manufacturing apparatus 1B of the second embodiment, similarly to the graphene manufacturing method using the graphene manufacturing apparatus 1A of the first embodiment described above, the manufacturing of the high quality graphene Sc can be realized. In addition, according to the graphene manufacturing apparatus 1B, the prism 6 is disposed, and thus the degree of freedom in disposition of the terahertz light source 3 and the photodetector 4 is improved.

[Third Embodiment] FIG. 5 is a configuration diagram of a graphene manufacturing apparatus according to a third embodiment. As illustrated in FIG. 5, a graphene manufacturing apparatus 1C according to the third embodiment is mainly different from the graphene manufacturing apparatus 1A according to the first embodiment in that the optical element 5 is not provided.

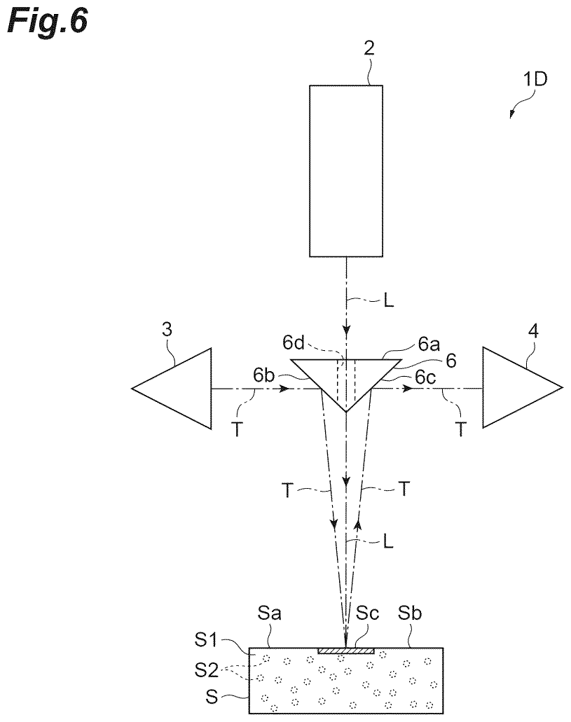

In the present embodiment, the laser beam L emitted from the laser beam source 2 is incident on the processing region Sb. The laser beam L is incident on the processing region Sb with the wavelength remained unconverted. That is, in the present embodiment, the laser beam L serves as both the processing laser beam and the evaluation laser beam. The laser beam L functions as each of the processing laser beam and the evaluation laser beam. In step S2 of the present embodiment, the laser beam L is used as the evaluation laser beam. In step S3 (third step) of the present embodiment, the laser beam L is used as the processing laser beam. In step S4 (fourth step) of the present embodiment, the laser beam L is used as the evaluation laser beam. That is, in step S4 of the present embodiment, the processing laser beam is used as the evaluation laser beam. In the present embodiment, the laser beam L is ultraviolet light. That is, in the present embodiment, each of the processing laser beam and the evaluation laser beam is ultraviolet light. The wavelength of the processing laser beam and the wavelength of the evaluation laser beam are the same. According to the graphene manufacturing method using the graphene manufacturing apparatus 1C of the third embodiment, similarly to the graphene manufacturing method using the graphene manufacturing apparatus 1A of the first embodiment described above, the manufacturing of the high quality graphene Sc can be realized. In addition, according to the graphene manufacturing method using the graphene manufacturing apparatus 1C of the third embodiment, the manufacturing of the graphene Sc with the simple configuration can be realized.

[Fourth Embodiment] FIG. 6 is a configuration diagram of a graphene manufacturing apparatus according to a fourth embodiment. As illustrated in FIG. 6, a graphene manufacturing apparatus 1D according to the fourth embodiment is mainly different from the graphene manufacturing apparatus 1C according to the third embodiment in that the prism 6 is further provided. The graphene manufacturing apparatus 1D according to the third embodiment is mainly different from the graphene manufacturing apparatus 1B according to the second embodiment in that the optical element 5 is not provided.

The prism 6 is disposed between the laser beam source 2 and the workpiece S. The laser beam L emitted from the laser beam source 2 passes through the through hole 6d of the prism 6 and then is incident on the processing region Sb of the surface Sa of the workpiece S. The terahertz wave T emitted from the terahertz light source 3 is reflected by the reflecting surface 6b and then incident on the processing region Sb. The terahertz wave T reflected by the processing region Sb is reflected by the reflecting surface 6c and then incident on the photodetector 4.

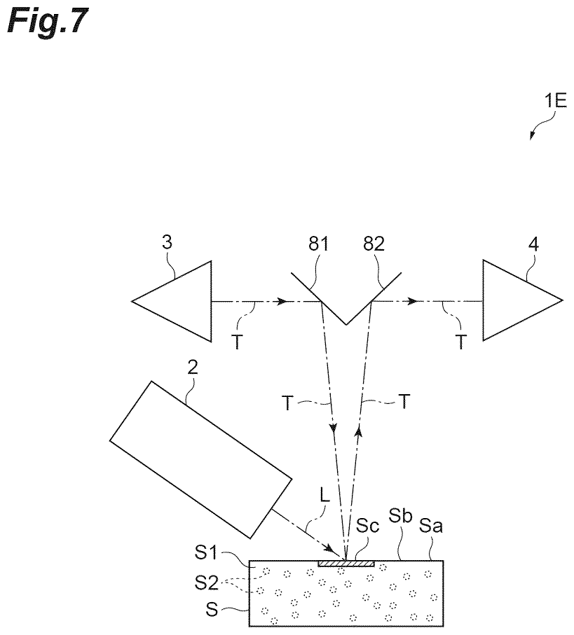

According to the graphene manufacturing method using the graphene manufacturing apparatus 1D of the fourth embodiment, similarly to the graphene manufacturing method using the graphene manufacturing apparatus 1A of the first embodiment described above, the manufacturing of the high quality graphene Sc can be realized. In addition, according to the graphene manufacturing method using the graphene manufacturing apparatus 1D, the prism 6 is disposed, and thus the degree of freedom in disposition of the terahertz light source 3 and the photodetector 4 is improved.

[Fifth Embodiment] FIG. 7 is a configuration diagram of a graphene manufacturing apparatus according to a fifth embodiment. As illustrated in FIG. 7, a graphene manufacturing apparatus 1E according to the fifth embodiment is mainly different from the graphene manufacturing apparatus 1C according to the third embodiment in that mirrors 81 and 82 are further provided.

The laser beam source 2 emits the laser beam L along a direction inclined with respect to the surface Sa of the workpiece S. The mirrors 81 and 82 are disposed between the terahertz light source 3 and the photodetector 4. The terahertz light source 3 emits the terahertz wave T along the direction parallel to the surface Sa. The terahertz wave T emitted from the terahertz light source 3 is reflected by the mirror 81 and then incident on the processing region Sb of the surface Sa of the workpiece S. The terahertz wave T reflected by the processing region Sb is reflected by the mirror 82 and then incident on the photodetector 4.

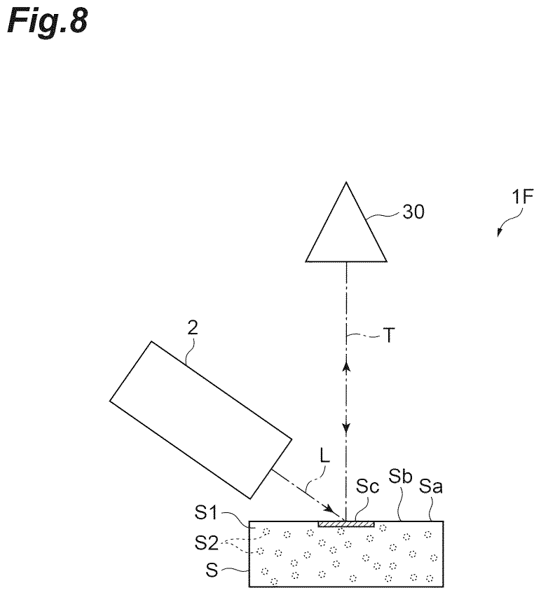

According to the graphene manufacturing method using the graphene manufacturing apparatus 1E of the fifth embodiment, similarly to the graphene manufacturing method using the graphene manufacturing apparatus 1A of the first embodiment described above, the manufacturing of the high quality graphene Sc can be realized. In addition, according to the graphene manufacturing method using the graphene manufacturing apparatus 1E, the mirrors 81 and 82 are disposed, and thus the degree of freedom in disposition of the laser beam source 2, the terahertz light source 3, and the photodetector 4 is improved.

[Sixth Embodiment] FIG. 8 is a configuration diagram of a graphene manufacturing apparatus according to a sixth embodiment. As illustrated in FIG. 8, a graphene manufacturing apparatus IF of the sixth embodiment is mainly different from the graphene manufacturing apparatus 1E of the fifth embodiment in that a terahertz detector 30 is provided instead of the terahertz light source 3, the photodetector 4, and the mirrors 81 and 82.

The terahertz detector 30 has functions of both emission of the terahertz wave T and detection of the terahertz wave T. The terahertz detector 30 emits the terahertz wave T along a direction perpendicular to the surface Sa. The terahertz wave T emitted from the terahertz detector 30 is reflected by the surface Sa and then incident on the terahertz detector 30.

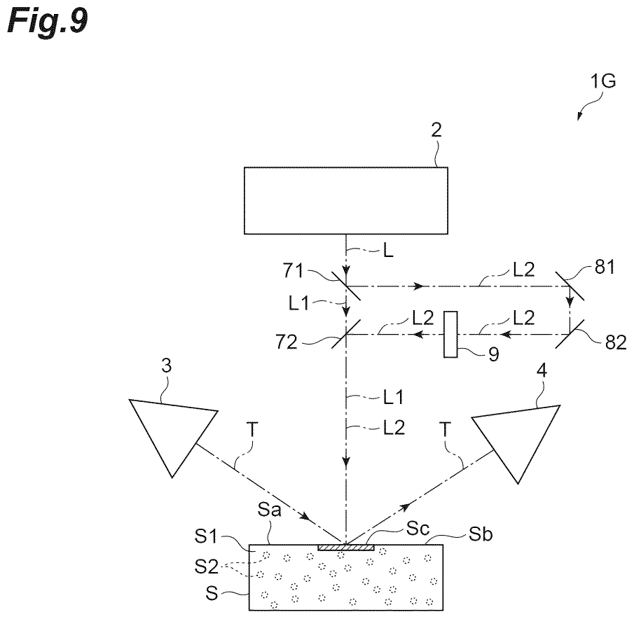

According to the graphene manufacturing method using the graphene manufacturing apparatus IF of the sixth embodiment, similarly to the graphene manufacturing method using the graphene manufacturing apparatus 1A of the first embodiment described above, the manufacturing of the high quality graphene Sc can be realized. In addition, according to the graphene manufacturing method using the graphene manufacturing apparatus IF, the manufacturing of the graphene Sc with the simple configuration can be realized.

[Seventh Embodiment] FIG. 9 is a configuration diagram of a graphene manufacturing apparatus according to a seventh embodiment. As illustrated in FIG. 9, a graphene manufacturing apparatus 1G according to the seventh embodiment is mainly different from the graphene manufacturing apparatus 1C according to the third embodiment in that beam splitters 71 and 72, mirrors 81 and 82, and an attenuator 9 are further provided.

The beam splitter 71 is disposed between the laser beam source 2 and the workpiece S. The beam splitter 72 is disposed between the beam splitter 71 and the workpiece S. The mirror 81 is disposed on one side of the beam splitter 71 in a direction parallel to the surface Sa of the workpiece S. The mirror 82 is disposed on one side of the beam splitter 72 in a direction parallel to the surface Sa of the workpiece S. The attenuator 9 is disposed between the mirror 82 and the beam splitter 72. The attenuator 9 attenuates a laser beam passing through the attenuator 9. The attenuator 9 reduces, for example, the intensity (light amount) of the laser beam.

A part of the laser beam L emitted from the laser beam source 2 is transmitted through, as the processing laser beam L1, the beam splitter 71. The other part of the laser beam L emitted from the laser beam source 2 is reflected, as the evaluation laser beam L2, by the beam splitter 71. The processing laser beam L1 transmitted through the beam splitter 71 passes through the beam splitter 72 and then is incident on the processing region Sb of the surface of the workpiece S. The evaluation laser beam L2 reflected by the beam splitter 71 is sequentially reflected by the mirrors 81 and 82 and then incident on the attenuator 9. The evaluation laser beam L2 incident on the attenuator 9 is attenuated and then emitted from the attenuator 9. The evaluation laser beam L2 emitted from the attenuator 9 is reflected by the beam splitter 72 and then incident on the processing region Sb.

In the present embodiment, an optical path length of the evaluation laser beam L2 is longer than an optical path length of the processing laser beam L1, and thus the evaluation laser beam L2 is incident on the same position as the processing laser beam L1 later than the processing laser beam L1. In the present embodiment, the wavelength of the processing laser beam L1 incident on the processing region Sb and the wavelength of the evaluation laser beam L2 incident on the processing region Sb are the same. Each of the wavelength of the processing laser beam L1 and the wavelength of the evaluation laser beam L2 is the same as the wavelength of the laser beam L. In the present embodiment, the evaluation laser beam L2 is attenuated by the attenuator 9, and thus the intensity of the evaluation laser beam L2 incident on the processing region Sb is smaller than the intensity of the processing laser beam L1 incident on the processing region Sb.

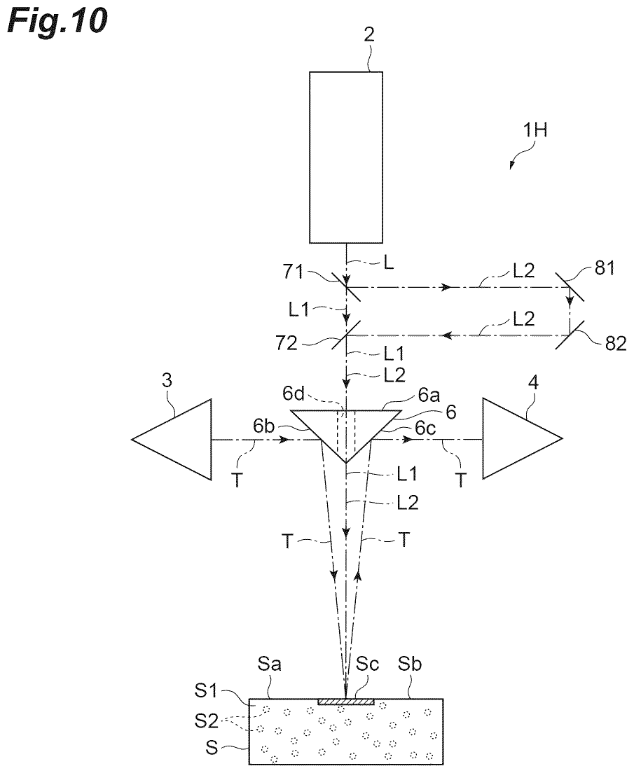

According to the graphene manufacturing method using the graphene manufacturing apparatus 1G of the seventh embodiment, similarly to the graphene manufacturing method using the graphene manufacturing apparatus 1A of the first embodiment described above, the manufacturing of the high quality graphene Sc can be realized. In addition, the intensity of the evaluation laser beam L2 incident on the processing region Sb is smaller than the intensity of the processing laser beam L1 incident on the processing region Sb. As a result, a change in quality of the graphene Sc caused by irradiation of the evaluation laser beam L2 can be suppressed. Therefore, the quality of the graphene Sc can be evaluated with further higher accuracy.

[Eighth Embodiment] FIG. 10 is a configuration diagram of a graphene manufacturing apparatus according to an eighth embodiment. As illustrated in FIG. 10, a graphene manufacturing apparatus 1H according to the eighth embodiment is mainly different from the graphene manufacturing apparatus 1D according to the fourth embodiment in that the beam splitters 71 and 72 and mirrors 81 and 82 are further provided. The graphene manufacturing apparatus 1H is mainly different from the graphene manufacturing apparatus 1G of the seventh embodiment in that the attenuator 9 is not provided and the prism 6 is further provided.

The prism 6 is disposed between the beam splitter 72 and the workpiece S. The evaluation laser beam L2 sequentially reflected by the mirrors 81 and 82 is incident on the beam splitter 72 without being attenuated. The processing laser beam L1 transmitted through the beam splitter 72 and the evaluation laser beam L2 reflected by the beam splitter 72 pass through the through hole 6d of the prism 6 and then are incident on the processing region Sb of the surface Sa of the workpiece S. The terahertz wave T emitted from the terahertz light source 3 is reflected by the reflecting surface 6b of the prism 6 and then incident on the workpiece S of the processing region Sb. The terahertz wave T reflected by the processing region Sb is reflected by the reflecting surface 6c of the prism 6 and then incident on the photodetector 4.

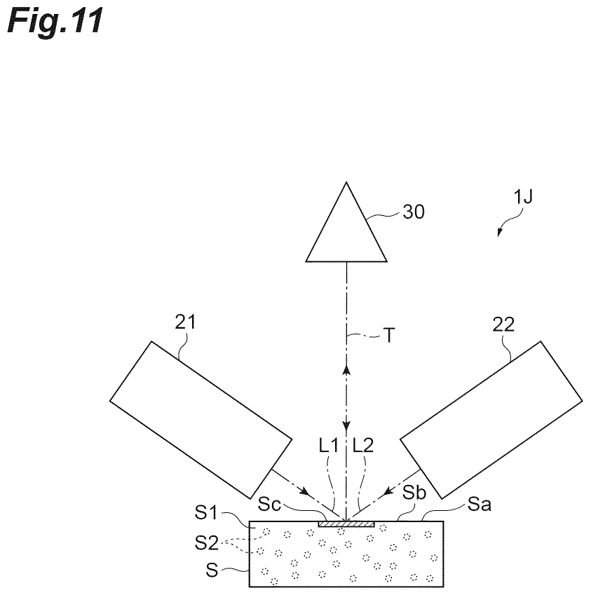

According to the graphene manufacturing method using the graphene manufacturing apparatus 1H of the eighth embodiment, similarly to the graphene manufacturing method using the graphene manufacturing apparatus 1A of the first embodiment described above, the manufacturing of the high quality graphene Sc can be realized.

[Ninth Embodiment] FIG. 11 is a configuration diagram of a graphene manufacturing apparatus according to a ninth embodiment. As illustrated in FIG. 11, a graphene manufacturing apparatus 1J according to the ninth embodiment is mainly different from the graphene manufacturing apparatus IF according to the sixth embodiment in that laser beam sources 21 and 22 are provided instead of the laser beam source 2.

The laser beam source 21 emits the processing laser beam L1 along a direction inclined with respect to the surface Sa. The laser beam source 22 emits the evaluation laser beam L2 along a direction inclined with respect to the surface Sa. In the present embodiment, the wavelength of the processing laser beam L1 and the wavelength of the evaluation laser beam L2 are the same.

According to the graphene manufacturing method using the graphene manufacturing apparatus 1J of the ninth embodiment, similarly to the graphene manufacturing method using the graphene manufacturing apparatus 1A of the first embodiment described above, the manufacturing of the high quality graphene Sc can be realized.

[Modified Example] Although the embodiments of the present disclosure have been described above, the present disclosure is not limited to the above-described embodiments.

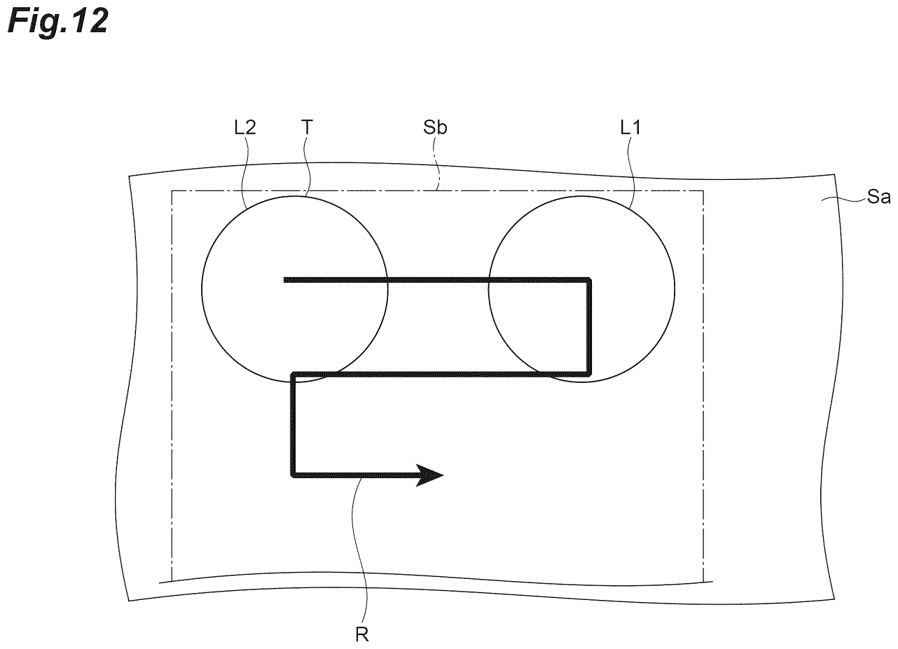

In each embodiment, the example has been described in which the irradiation position of the terahertz wave T in the processing region Sb overlaps the irradiation position of the processing laser beam L1 in the processing region Sb. However, as illustrated in FIG. 12, the irradiation position of the terahertz wave T in the processing region Sb may be away from the irradiation position of the processing laser beam L1 in the processing region Sb. In this case, the center of the irradiation range of the terahertz wave T is away from the center of the irradiation range of the processing laser beam L1. The irradiation range of the terahertz wave T is away from the irradiation range of the processing laser beam L1. The irradiation range of the terahertz wave T may partially overlap the irradiation range of the processing laser beam L1. The terahertz wave T is radiated to the downstream side of the processing laser beam L1 in the path R. The terahertz wave T is radiated to a position after being irradiated with the processing laser beam L1.

The irradiation position of the evaluation laser beam L2 in the processing region Sb overlaps the irradiation position of the terahertz wave T in the processing region Sb. That is, the irradiation position of the evaluation laser beam L2 in the processing region Sb is away from the irradiation position of the processing laser beam L1 in the processing region Sb. The center of the irradiation range of the evaluation laser beam L2 is away from the center of the irradiation range of the processing laser beam L1. The irradiation range of the evaluation laser beam L2 is away from the irradiation range of the processing laser beam L1. The irradiation range of the evaluation laser beam L2 may partially overlap the irradiation range of the processing laser beam L1. Similarly to the terahertz wave T, the evaluation laser beam L2 is radiated to the downstream side of the processing laser beam L1 in the path R. Similarly to the terahertz wave T, the evaluation laser beam L2 is radiated to the position after being irradiated with the processing laser beam L1.

In such a case, the manufacturing of the graphene Sc and the quality evaluation of the graphene Sc are less likely to be affected by each other, and thus the accuracy of each of the manufacturing of the graphene Sc and the quality evaluation of the graphene Sc can be improved.

In each embodiment, the example has been described in which the terahertz wave T is reflected by the processing region Sb. However, in each embodiment excluding the sixth embodiment (see FIG. 8) and the ninth embodiment (see FIG. 11), the terahertz wave T may be transmitted through the workpiece S. In this case, the photodetector 4 detects the terahertz wave T transmitted through the workpiece S.

In each embodiment, the example has been described in which when the quality of the graphene Sc is evaluated to be low, the energy of the processing laser beam L1 incident on the processing region Sb is increased. However, when the quality of the graphene Sc is evaluated to be inappropriate, the energy of the processing laser beam L1 incident on the processing region Sb may be decreased. In each embodiment, the energy of the processing laser beam L1 may be adjusted until the quality of the graphene Sc reaches a target quality.

The graphene manufacturing apparatus 1G according to the seventh embodiment (see FIG. 9) may not include the attenuator 9.

In the ninth embodiment (see FIG. 11), the example has been described in which the wavelength of the processing laser beam L1 and the wavelength of the evaluation laser beam L2 are the same. However, the wavelength of the processing laser beam L1 and the wavelength of the evaluation laser beam L2 may be different from each other. The wavelength of the evaluation laser beam L2 may be larger than the wavelength of the processing laser beam L1.

In each embodiment, the example has been described in which the evaluation laser beam L2 is radiated to the same position at the same time as the terahertz wave T. However, the irradiation position of the evaluation laser beam L2 may not completely coincide with the irradiation position of the terahertz wave T. The irradiation position of the evaluation laser beam L2 may be different from the irradiation position of the terahertz wave T. The irradiation position (irradiation range) of the evaluation laser beam L2 may, for example, partially overlap the irradiation position (irradiation range) of the terahertz wave T. The irradiation position (irradiation range) of the evaluation laser beam L2 may be, for example, away from the irradiation position (irradiation range) of the terahertz wave T. The irradiation timing of the evaluation laser beam L2 may not completely coincide with the irradiation timing of the terahertz wave T. The irradiation timing of the evaluation laser beam L2 may be different from the irradiation timing of the terahertz wave T. The evaluation laser beam L2 may enhance the terahertz wave T. The terahertz wave T may be radiated to the inside of a range of the electric field formed by the irradiation of the evaluation laser beam L2.

In each embodiment, the example has been described in which the terahertz wave T and the evaluation laser beam L2 scan over the entire processing region Sb. However, only a part of the processing region Sb may be irradiated with the terahertz wave T and the evaluation laser beam L2. In this case, the quality of the graphene Sc in the processing region Sb may be evaluated based on the detection result of the terahertz wave T from only the part of the processing region Sb (using the detection result as a representative value).

A graphene manufacturing method of the present disclosure is [1] “A graphene manufacturing method including a first step of preparing a workpiece including a base material made of a resin material and a plant powder dispersed in the base material, a second step of irradiating a surface of the workpiece with a terahertz wave and an evaluation laser beam and detecting the terahertz wave from the surface, a third step of irradiating a processing region of the surface with a processing laser beam to form graphene in the processing region, a fourth step of irradiating the processing region with the terahertz wave and the evaluation laser beam and detecting the terahertz wave from the processing region, and a fifth step of evaluating quality of the graphene in the processing region based on an intensity difference between the terahertz wave detected in the fourth step and the terahertz wave detected in the second step.”.

In the fifth step of the graphene manufacturing method according to [1], the quality of graphene in the processing region is evaluated based on the intensity difference between the terahertz wave detected in the fourth step and the terahertz wave detected in the second step. That is, in the fifth step, the quality of graphene is evaluated using, for example, the terahertz wave having a longer wavelength than visible light or infrared light. As a result, for example, even when unevenness or the like exists in the processing region, noise caused by the unevenness is reduced, and thus the quality of graphene can be evaluated with higher accuracy. Moreover, in the fourth step, the processing region is irradiated with the evaluation laser beam in addition to the terahertz wave. As a result, when graphene is formed in the processing region, the terahertz wave is enhanced by the evaluation laser beam, and thus the quality of graphene can be evaluated with higher accuracy. Therefore, highly accurate setting of the radiation condition of the processing laser beam can be realized based on the highly accurate evaluation result of the quality of graphene. Therefore, according to this graphene manufacturing method, manufacturing of high quality graphene can be realized.

The graphene manufacturing method of the present disclosure may be [2] “The graphene manufacturing method according to [1], wherein in the fifth step, the larger the intensity difference of the terahertz wave is, the higher the quality of graphene is evaluated.”. As a result, highly accurate setting of the radiation condition of the processing laser beam can be realized, and the manufacturing of the high quality graphene can be realized.

The graphene manufacturing method of the present disclosure may be [3] “The graphene manufacturing method according to [1] or [2], further including a sixth step of adjusting a radiation condition of the processing laser beam with respect to the processing region based on the evaluation result in the fifth step.”. As a result, the radiation condition of the processing laser beam can be set with high accuracy, and the high quality graphene can be manufactured.

The graphene manufacturing method of the present disclosure may be [4] “The graphene manufacturing method according to [3], wherein in the sixth step, when the intensity difference is smaller than a predetermined value, an energy of the processing laser beam incident on the processing region is increased.”. When the intensity difference is smaller than a predetermined value, the quality of graphene may not meet a predetermined condition. According to this method, when the intensity difference is smaller than the predetermined value, the quality of graphene can be improved by increasing the energy of the processing laser beam.

The graphene manufacturing method of the present disclosure may be [5] “The graphene manufacturing method according to any one of [1] to [4], wherein the third step and the fourth step are simultaneously executed.”. As a result, the improvement of the manufacturing efficiency of graphene can be realized.

The graphene manufacturing method of the present disclosure may be [6] “The graphene manufacturing method according to any one of [1] to [5], wherein the processing laser beam and the evaluation laser beam are emitted from the same laser beam source.”. As a result, the manufacturing of graphene with the simple configuration can be realized.

The graphene manufacturing method of the present disclosure may be [7] “The graphene manufacturing method according to any one of [1] to [6], wherein each of the processing laser beam and the evaluation laser beam is a femtosecond laser beam.”. As a result, the manufacturing of graphene with the simple configuration can be realized.

The graphene manufacturing method of the present disclosure may be [8] “The graphene manufacturing method according to any one of [1] to [7], wherein an irradiation position of the processing laser beam and an irradiation position of the evaluation laser beam in the processing region overlap each other.”. As a result, the manufacturing of graphene and the quality evaluation of graphene can be simultaneously executed and the improvement of the manufacturing efficiency of graphene can be realized.

The graphene manufacturing method of the present disclosure may be [9] “The graphene manufacturing method according to any one of [1] to [7], wherein an irradiation position of the processing laser beam and an irradiation position of the evaluation laser beam in the processing region are away from each other.”. As a result, the manufacturing of graphene and the quality evaluation of graphene are less likely to be affected by each other, and thus the accuracy of each of the manufacturing of graphene and the quality evaluation of graphene can be improved.

The graphene manufacturing method of the present disclosure may be “The graphene manufacturing method according to any one of [1] to [9], wherein an intensity of the evaluation laser beam incident on the processing region is smaller than an intensity of the processing laser beam incident on the processing region.”. As a result, a change in quality of graphene caused by irradiation of the evaluation laser beam can be suppressed.

The graphene manufacturing method of the present disclosure may be “The graphene manufacturing method according to any one of [1] to [10], wherein a wavelength of the processing laser beam incident on the processing region and a wavelength of the evaluation laser beam incident on the processing region are different from each other.”. As a result, laser beams each having a wavelength suitable for a respective one of the manufacturing of graphene and the quality evaluation of graphene can be used, and the accuracy of each of the manufacturing of graphene and the quality evaluation of graphene can be improved.

The graphene manufacturing method of the present disclosure may be “The graphene manufacturing method according to [11], wherein the wavelength of the evaluation laser beam is larger than the wavelength of the processing laser beam.”. As a result, laser beams each having a wavelength suitable for a respective one of the manufacturing of graphene and the quality evaluation of graphene can be used, and the accuracy of each of the manufacturing of graphene and the quality evaluation of graphene can be improved.

The graphene manufacturing method of the present disclosure may be [13] “The graphene manufacturing method according to any one of [1] to [10], wherein a wavelength of the processing laser beam and a wavelength of the evaluation laser beam are the same.”. As a result, the manufacturing of graphene with the simple configuration can be realized.

The graphene manufacturing method of the present disclosure may be [14] “The graphene manufacturing method according to [13], wherein each of the processing laser beam and the evaluation laser beam is ultraviolet light.”. As a result, the manufacturing of graphene with the simple configuration can be realized.

The graphene manufacturing method of the present disclosure may be “The graphene manufacturing method according to [13] or [14], wherein in the fourth step, the processing laser beam is used as the evaluation laser beam.”. As a result, the manufacturing of graphene with the simple configuration can be realized.

According to the present disclosure the graphene manufacturing method capable of realizing the manufacturing of high quality graphene can be provided.

What is claimed is:

1. A graphene manufacturing method comprising:
a first step of preparing a workpiece including a base material made of a resin material and a plant powder dispersed in the base material;
a second step of irradiating a surface of the workpiece with a terahertz wave and an evaluation laser beam and detecting the terahertz wave from the surface;
a third step of irradiating a processing region of the surface with a processing laser beam to form graphene in the processing region;
a fourth step of irradiating the processing region with the terahertz wave and the evaluation laser beam and detecting the terahertz wave from the processing region; and
a fifth step of evaluating quality of the graphene in the processing region based on an intensity difference between the terahertz wave detected in the fourth step and the terahertz wave detected in the second step.

2. The graphene manufacturing method according to claim 1, wherein in the fifth step, the larger the intensity difference of the terahertz wave is, the higher the quality of graphene is evaluated.

3. The graphene manufacturing method according to claim 1, further comprising a sixth step of adjusting a radiation condition of the processing laser beam with respect to the processing region based on the evaluation result in the fifth step.

4. The graphene manufacturing method according to claim 3, wherein in the sixth step, when the intensity difference is smaller than a predetermined value, an energy of the processing laser beam incident on the processing region is increased.

5. The graphene manufacturing method according to claim 1, wherein the third step and the fourth step are simultaneously executed.

6. The graphene manufacturing method according to claim 1, wherein the processing laser beam and the evaluation laser beam are emitted from the same laser beam source.

7. The graphene manufacturing method according to claim 1, wherein each of the processing laser beam and the evaluation laser beam is a femtosecond laser beam.

8. The graphene manufacturing method according to claim 1, wherein an irradiation position of the processing laser beam and an irradiation position of the evaluation laser beam in the processing region overlap each other.

9. The graphene manufacturing method according to claim 1, wherein an irradiation position of the processing laser beam and an irradiation position of the evaluation laser beam in the processing region are away from each other.

10. The graphene manufacturing method according to claim 1, wherein an intensity of the evaluation laser beam incident on the processing region is smaller than an intensity of the processing laser beam incident on the processing region.

11. The graphene manufacturing method according to claim 1, wherein a wavelength of the processing laser beam incident on the processing region and a wavelength of the evaluation laser beam incident on the processing region are different from each other.

12. The graphene manufacturing method according to claim 11, wherein the wavelength of the evaluation laser beam is larger than the wavelength of the processing laser beam.

13. The graphene manufacturing method according to claim 1, wherein a wavelength of the processing laser beam and a wavelength of the evaluation laser beam are the same.

14. The graphene manufacturing method according to claim 13, wherein each of the processing laser beam and the evaluation laser beam is ultraviolet light.

15. The graphene manufacturing method according to claim 13, wherein in the fourth step, the processing laser beam is used as the evaluation laser beam.
